(19) United States
(12) Patent Application Publication
(10) Pub. No.: US 2009/0225150 A1
(43) Pub. Date: Sep. 10, 2009

(54) LIGHT-EMITTING HEAD AND PRINTING APPARATUS USING THE SAME

(75) Inventors: Isao Ebisawa, Hamura-shi (JP); Yoshiyuki Matsuoka, Tokorozawa-shi (JP); Kenji Kobayashi, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/396,681

(22) Filed: Mar. 3, 2009

(30) Foreign Application Priority Data
Mar. 4, 2008 (JP) 2008-053742

(51) Int. Cl. B41J 2/455

(52) U.S. Cl. 347/233

(57) ABSTRACT

A light-emitting head of a printing apparatus includes luminescent elements on a substrate. Each of the luminescent elements includes micro-light-emitting portions. A direction of a perpendicular bisector of a straight line joining centers of each micro-light-emitting portion of each luminescent element and another micro-light-emitting portion of the same luminescent element which is nearest to the each micro-light-emitting portion is off a luminescent element adjacent to the luminescent element.

### CROSS-REFERENCE TO RELATED APPLICATIONS

This application is based upon and claims the benefit of priority from prior Japanese Patent Application No. 2008-053742, filed Mar. 4, 2008, the entire contents of which are incorporated herein by reference.

### BACKGROUND OF THE INVENTION

1. Field of the Invention

The present invention relates to a light-emitting head in a printing apparatus.

2. Description of the Related Art

There has been proposed a technique associated with a conventional printing apparatus, which uses a light-emitting diode or a scanner unit having a laser diode as a light source as an exposure device for a photosensitive member in an electrophotographic scheme or the like. Recently, a printing apparatus using an organic EL element has also been proposed.

In a printing apparatus using an organic EL element, in order to satisfy the requirement concerning the service life of the organic EL element while securing a light amount necessary for the photosensitive member of the printing apparatus, it is conceivable to prolong the exposure time by decreasing the luminescence intensity of the organic EL element. This will prolong the printing time. If the luminescence intensity of an organic EL element is increased to increase the printing speed, the Joule heat generated by a high current density becomes a factor that shortens the service life of the organic EL element.

As a means for solving this problem, there has been proposed a multiple exposure technique of repeatedly exposing the same region of a photosensitive member with organic EL elements. In this multiple exposure technique, a sufficient service life is secured for each organic EL element because the luminance of each organic EL element is suppressed low while sufficient energy is supplied to an exposure region of a photosensitive member (see patent reference 1: Jpn. Pat. Appln. KOKAI Publication No. 2003-341141).

The above multiple exposure technique accompanies complexity of design or control. From the viewpoint of easy design or control, therefore, a preferable arrangement is to expose one element with one organic EL element. It is therefore desirable to provide an organic EL element having a sufficient service life even in use with a sufficient luminescence intensity. That is, there are demands for improvement in the service life of an organic EL element.

### BRIEF SUMMARY OF THE INVENTION

The present invention has been made in consideration of the above situation, and has as its object to provide a light-emitting head having a luminescent element with an improved service life.

A light-emitting head of a printing apparatus according to the present invention includes luminescent elements on a substrate, each of the luminescent elements including micro-light-emitting portions. A direction of a perpendicular bisector of a straight line joining centers of each micro-light-emitting portion of each luminescent element and another micro-light-emitting portion of the same luminescent element which is nearest to the each micro-light-emitting portion is off a luminescent element adjacent to the luminescent element.

The micro-light-emitting portions of each of the luminescent elements includes a first micro-light-emitting portion nearest to an adjacent luminescent element, and a second micro-light-emitting portion which is nearest to the first micro-light-emitting portion, with a distance to the adjacent luminescent element being longer than a distance between the first micro-light-emitting portion and the adjacent luminescent element. A direction of a perpendicular bisector of a straight line joining centers of the first micro-light-emitting portion and the second micro-light-emitting portion is off a luminescent element adjacent to the luminescent element.

The light-emitting head further includes first electrodes, at least one second electrode facing the first electrodes, and an emitting layer and an insulating layer which are located between the first electrodes and the second electrode. The insulating layer includes opening portions in each of areas where each of the first electrodes faces the second electrode. Each of the opening portions defines one of the micro-light-emitting portions.

The luminescent elements are staggered arranged at a predetermined pitch in a main scanning direction. The light-emitting head further includes microlenses which respectively correspond to the luminescent elements and each have a curvature radius larger than the predetermined pitch.

The luminescent element includes the four micro-light-emitting portions.

The light-emitting head further includes first electrodes, at least one second electrode facing the first electrodes, and an emitting layer located between the first electrodes and the second electrode. The micro-light-emitting portions are provided in a substantially rectangular area on the first electrode and the micro-light-emitting portions are provided at middles of sides of the substantially rectangular area.

Each side of the substantially rectangular area extends along one of a main scanning direction and a sub-scanning direction.

The light-emitting head further includes first electrodes, at least one second electrode facing the first electrodes, and an emitting layer and a heat dissipation portion which are located between the first electrodes and the second electrode. The heat dissipation portion is located between the substrate and one of the first electrodes.

The light-emitting head comprises an organic EL head.

A light-emitting head of a printing apparatus according to the present invention includes luminescent elements staggered arranged at a predetermined pitch in a main scanning direction, and microlenses which respectively correspond to the luminescent elements and each have a curvature radius larger than the predetermined pitch.

A microlens array on which the microlenses are formed includes a light-shielding plate on a side opposite to a surface on which the microlenses are formed.

The light-shielding plate includes optical openings respectively corresponding to the luminescent elements.

The light-emitting head further includes first electrodes, at least one second electrode facing the first electrodes, an emitting layer located between the first electrodes and the second electrode, a sealing film on a multilayer structure of the first electrodes, emitting layer, and second electrode, and a core on the sealing film.

The sealing layer comprises a material having a lower refractive index than the core.

A printing apparatus according to the present invention includes a printing unit which prints a toner image on a printing medium. The printing unit includes a photosensitive drum, a charging roller which uniformly charges a surface of the photosensitive drum, a light-emitting head which forms an electrostatic latent image on the photosensitive drum, a developing device which develops the electrostatic latent image by attracting toner to the electrostatic latent image, and a transfer roller which transfers the toner attracted to the electrostatic latent image onto a sheet. The light-emitting head includes luminescent elements on a substrate, each of the luminescent elements including micro-light-emitting portions. A direction of a perpendicular bisector of a straight line joining centers of each micro-light-emitting portion of each luminescent element and another micro-light-emitting portion of the same luminescent element which is nearest to the each micro-light-emitting portion is off a luminescent element adjacent to the luminescent element.

The micro-light-emitting portions of each of the luminescent elements includes a first micro-light-emitting portion nearest to an adjacent luminescent element, and a second micro-light-emitting portion which is nearest to the first micro-light-emitting portion, with a distance to the adjacent luminescent element being longer than a distance between the first micro-light-emitting portion and the adjacent luminescent element. A direction of a perpendicular bisector of a straight line joining centers of the first micro-light-emitting portion and the second micro-light-emitting portion is off a luminescent element adjacent to the luminescent element.

The light-emitting head includes first electrodes, at least one second electrode facing the first electrodes, and an emitting layer and an insulating layer which are located between the first electrodes and the second electrode. The insulating layer includes opening portions in each of areas where each of the first electrodes faces the second electrode. Each of the opening portions defines one of the micro-light-emitting portions.

The luminescent elements are staggered arranged at a predetermined pitch in a main scanning direction. The printing apparatus further includes microlenses which respectively correspond to the luminescent elements and each have a curvature radius larger than the predetermined pitch.

The light-emitting head includes first electrodes, at least one second electrode facing the first electrodes, and an emitting layer located between the first electrodes and the second electrode. The luminescent element includes the four micro-light-emitting portions. The micro-light-emitting portions are provided in a substantially rectangular area on the first electrode and the micro-light-emitting portions are provided at middles of sides of the substantially rectangular area.

The light-emitting head comprises an organic EL head.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a printing apparatus according to an embodiment of the present invention;

FIG. 2 is a sectional view of an organic EL head shown in FIG. 1;

FIG. 3 is a view showing the luminescent element substrate and housing of the organic EL head shown in FIG. 2;

FIG. 4 is a plan view of the luminescent element substrate shown in FIG. 3;

FIG. 5 is a plan view of a bottom emission type organic EL element array shown in FIG. 4;

FIG. 6 is a cross-sectional view taken along a line VI-VI of the organic EL element shown in FIG. 5;

FIG. 7 is a sectional view of another organic EL element which can replace the bottom emission type organic EL element shown in FIG. 6;

FIG. 8 is a sectional view of a top emission type organic EL element which can replace the bottom emission type organic EL element shown in FIG. 6;

FIG. 9 is a view showing the layout of the micro-light-emitting portions of the organic EL element shown in FIGS. 4 to 8;

FIG. 10 is a 2D graph of a heating pattern obtained 50 ms after heat generation by the organic EL element having the micro-light-emitting portions arranged in the layout shown in FIG. 9;

FIG. 11 is a 3D graph of a heating pattern obtained 50 ms after heat generation by the organic EL element having the micro-light-emitting portions arranged in the layout shown in FIG. 9;

FIG. 12 is a 2D graph of a heating pattern obtained 80 ms after heat generation by the organic EL element having the micro-light-emitting portions arranged in the layout shown in FIG. 9;

FIG. 13 is a 3D graph of a heating pattern obtained 80 ms after heat generation by the organic EL element having the micro-light-emitting portions arranged in the layout shown in FIG. 9;

FIG. 14 is a 2D graph of a heating pattern obtained 100 ms after heat generation by the organic EL element having the micro-light-emitting portions arranged in the layout shown in FIG. 9;

FIG. 15 is a 3D graph of a heating pattern obtained 100 ms after heat generation by the organic EL element having the micro-light-emitting portions arranged in the layout shown in FIG. 9;

FIG. 16 is a 2D graph of a heating pattern obtained 130 ms after heat generation by the organic EL element having the micro-light-emitting portions arranged in the layout shown in FIG. 9;

FIG. 17 is a 3D graph of a heating pattern obtained 130 ms after heat generation by the organic EL element having the micro-light-emitting portions arranged in the layout shown in FIG. 9;

FIG. 18 is a view showing another layout of micro-light-emitting portions as a comparative example of FIG. 9;

FIG. 19 is a 2D graph of a heating pattern obtained 50 ms after heat generation by the organic EL element having the micro-light-emitting portions arranged in the layout shown in FIG. 18;

FIG. 20 is a 3D graph of a heating pattern obtained 50 ms after heat generation by the organic EL element having the micro-light-emitting portions arranged in the layout shown in FIG. 18;

FIG. 21 is a 2D graph of a heating pattern obtained 80 ms after heat generation by the organic EL element having the micro-light-emitting portions arranged in the layout shown in FIG. 18;

FIG. 22 is a 3D graph of a heating pattern obtained 80 ms after heat generation by the organic EL element having the micro-light-emitting portions arranged in the layout shown in FIG. 18;

FIG. 23 is a 2D graph of a heating pattern obtained 100 ms after heat generation by the organic EL element having the micro-light-emitting portions arranged in the layout shown in FIG. 18;

FIG. 24 is a 3D graph of a heating pattern obtained 100 ms after heat generation by the organic EL element having the micro-light-emitting portions arranged in the layout shown in FIG. 18;

FIG. 25 is a 2D graph of a heating pattern obtained 130 ms after heat generation by the organic EL element having the micro-light-emitting portions arranged in the layout shown in FIG. 18;

FIG. 26 is a 3D graph of a heating pattern obtained 130 ms after heat generation by the organic EL element having the micro-light-emitting portions arranged in the layout shown in FIG. 18;

FIG. 27 is a view showing an organic EL head which resolves the respective dots;

FIG. 28 is an enlarged view of the organic EL element array and microlens array shown in FIG. 27;

FIG. 29 is a view showing the layout of the arrays of organic EL elements and microlenses shown in FIG. 28;

FIG. 30 is a view showing one combination of an organic EL element and a microlens shown in FIG. 28;

FIG. 31 is a graph showing the light-receiving profile of light emitted from an organic EL element and applied, via a microlens, to a light-receiving surface spaced apart from the distal end of the microlens by 1 mm;

FIG. 32 is view showing the organic EL element shown in FIGS. 28 to 30;

FIG. 33 is a view showing a directivity simulation result on a general organic EL element which emits perfect diffused light;

FIG. 34 is a view showing a directivity simulation result on an organic EL element having a refractive index difference waveguide having a length of 10 μm; and

FIG. 35 is a view showing a directivity simulation result on an organic EL element having a refractive index difference waveguide having a length of 20 μm.

### DETAILED DESCRIPTION OF THE INVENTION

An embodiment of the present invention will be described below with reference to the views of the accompanying drawing.

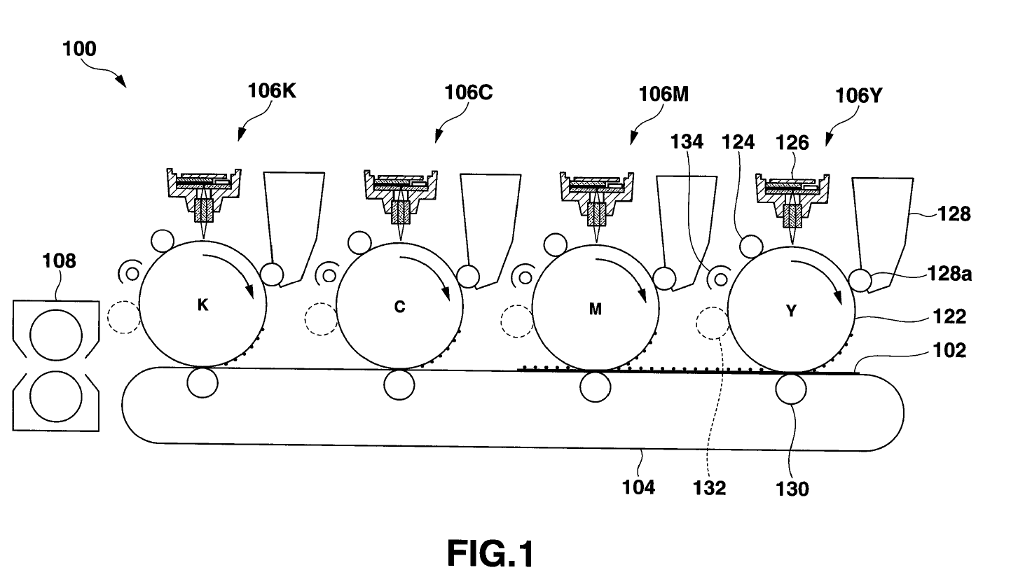

FIG. 1 shows a printing apparatus according to an embodiment of the present invention. As shown in FIG. 1, a printing apparatus 100 includes a convey belt 104 which conveys a sheet 102, four printing units 106Y, 106M, 106C, and 106K which are arranged along the convey belt 104 to respectively print toner images of four colors on the sheet 102, and fixing rollers 108 which are arranged downstream of the convey belt 104 to fix the toner images formed on the sheet 102.

The four printing units 106Y, 106M, 106C, and 106K comprise an yellow printing unit 106Y, a magenta printing unit 106M, a cyan printing unit 106C, and a black printing unit 106K. The four printing units 106Y, 106M, 106C, and 106K differ only in the use of toners of different colors and basically have the same mechanical structure. In the following description, if the printing units 106Y, 106M, 106C, and 106K need not be discriminated from each other, they are representatively denoted by reference numeral 106.

Each printing unit 106 includes a photosensitive drum 122, a charging roller 124 which uniformly charges the surface of the photosensitive drum 122, an organic EL head 126 which forms an electrostatic latent image on the photosensitive drum 122, a developing device 128 which develops the electrostatic latent image by attracting toner to the electrostatic latent image, a transfer roller 130 which transfers the toner attracted to the electrostatic latent image onto the sheet 102, a cleaning device 132 which removes non-transferred toner, and an eraser light source 134 which uniformly discharges the surface of the photosensitive drum 122. The photosensitive drum 122 is a negative charge type OPC photosensitive member. The charging roller 124 is a negative charger.

The charging roller 124 applies a negative high voltage from a charging power supply (not shown) onto the photosensitive drum 122. This uniformly and negatively charges the outer surface of the photosensitive drum 122, thereby initializing the drum. The organic EL head 126 optically writes (exposes) on the charged photosensitive drum 122 in accordance with print information. With this exposure, an electrostatic latent image constituted by a negative low potential portion and a negative high potential portion obtained by initialization charging is formed on the outer surface of the photosensitive drum 122. A developing roller 128a rotates and carries toner stored in the developing device 128 and charged to a weak negative potential onto a portion facing the photosensitive drum 122. A developing bias of −250 V from a power supply (not shown) is applied to the developing roller 128a to form a potential difference of −200 V between the portion to which the bias is applied and a low potential portion with −50 V of the electrostatic latent image on the outer surface of the photosensitive drum 122. With this operation, the toner charged to the negative polarity transfers to the low potential portion of the electrostatic latent image set at a potential of positive polarity relative to the developing roller 128a to form a toner image. At this time, the toner attraction amount of the formed toner image (the density of the developed image) is determined by a potential attenuation amount corresponding to the amount of exposure on the photosensitive member. This toner image is carried to a portion (transfer portion) between the photosensitive drum 122 and the transfer roller 130 by the rotation of the photosensitive drum 122. The convey belt 104 conveys a sheet to the transfer portion. The transfer roller 130 transfers the toner image formed on the photosensitive drum 122 onto the sheet.

The sheet 102 is sequentially conveyed to the four printing units 106Y, 106M, 106C, and 106K by the convey belt 104. The printing units 106Y, 106M, 106C, and 106K print toner images of four colors so as to superimpose them on each other. Each printing unit 106 performs printing operation in the above manner. The sheet 102 on which the toner images of the four colors are printed on each other is conveyed to the fixing rollers 108. After the toner images are thermally fixed by the fixing rollers 108, the sheet is delivered outside the printing apparatus 100.

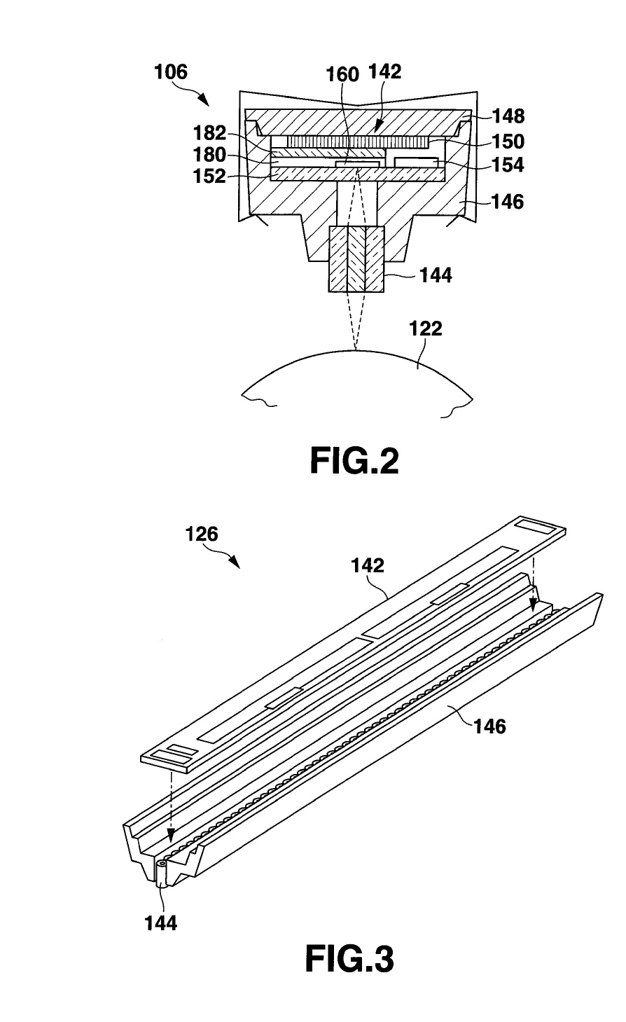

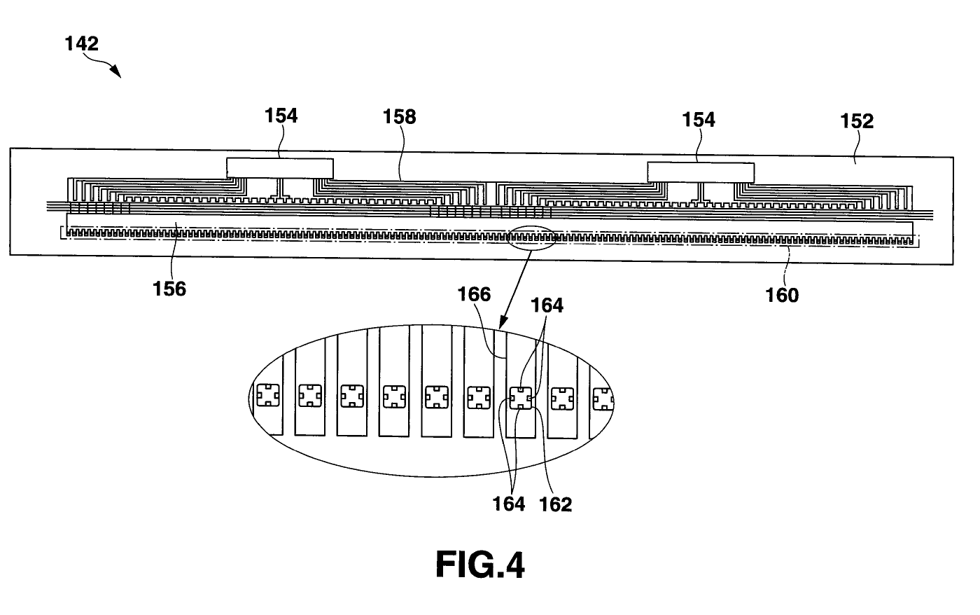

FIG. 2 is a sectional view of the organic EL head 126. FIG. 3 is a view showing a luminescent element substrate 142 and a housing 146 of the organic EL head 126. FIG. 4 is a plan view of the luminescent element substrate 142.

As shown in FIGS. 2 and 3, the organic EL head 126 includes the luminescent element substrate 142, an erecting one-to-one imaging rod lens array 144, the housing 146 which houses the luminescent element substrate 142, a cover 148 which covers the opening of the housing 146, and a fixing member 150 interposed between the luminescent element substrate 142 and the cover 148. The rod lens array 144 is fixed to the housing 146 and forms light exiting from the luminescent element substrate 142 into an image on the photosensitive drum 122.

As shown in FIG. 4, the luminescent element substrate 142 includes a transparent substrate 152 made of a glass material or the like, drivers 154, a TFT active matrix lighting circuit 156, and an organic EL element array 160. The drivers 154 are bonded on the transparent substrate 152. The drivers 154 are connected to the TFT active matrix lighting circuit 156 via interconnections 158 such as data lines and scanning lines. The TFT active matrix lighting circuit 156 is connected to many transparent pixel electrodes 166 so as to face the organic EL element array 160. As partly enlarged and shown in the ellipse in FIG. 4, the distal end portion of each pixel electrode 166 is one organic EL element 162.

The organic EL element array 160 includes many organic EL elements 162 respectively positioned at the distal end portions of the many pixel electrodes 166. The organic EL elements 162 are aligned in the main scanning direction (the widthwise direction of the photosensitive drum, i.e., the widthwise direction of a sheet). In the case of a general 600-dpi printing apparatus, the dot pitch is 42.3 μm, and the size of each organic EL element 162 is approximately 21 μm square. Each organic EL element 162 has four micro-light-emitting portions 164. In one organic EL element 162, one micro-light-emitting portion 164 corresponds to one sub-pixel, and four sub-pixels constitute one pixel.

The drivers 154 output control signals containing print data to the TFT active matrix lighting circuit 156 via the interconnections 158. The TFT active matrix lighting circuit 156 applies currents or voltages corresponding to print data to the pixel electrodes 166 at predetermined timings, which causes each organic EL element 162 to emit light with a luminance based on the print data.

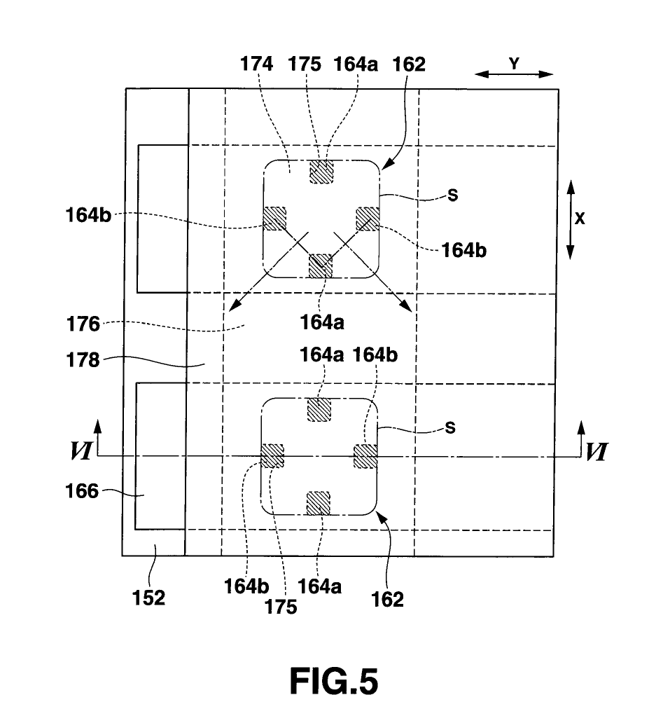

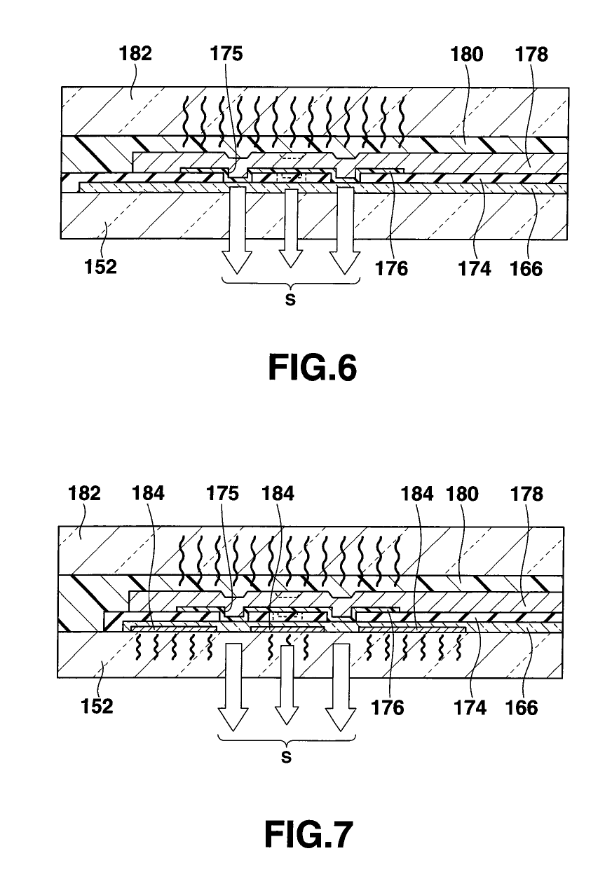

FIG. 5 is a plan view of the bottom emission type organic EL element array 160. FIG. 6 is a cross-sectional view taken along a line VI-VI of the organic EL element 162 shown in FIG. 5.

The organic EL element array 160 includes pixel electrodes 166 functioning as anodes, at least one light-reflecting counter electrode 178 facing the pixel electrodes 166 and functioning as a cathode, and an insulating layer 174 and an organic EL layer 176 which are located between the pixel electrodes 166 and the counter electrode 178. The pixel electrodes 166, the insulating layer 174, the organic EL layer 176, and the counter electrode 178 are stacked on the transparent substrate 152. This multilayer structure is covered by a sealing layer 180 and a sealing substrate 182. The pixel electrodes 166 are aligned in the main scanning direction (indicated by an arrow X in FIG. 5) at predetermined intervals so as to extend in the sub-scanning direction (indicated by an arrow Y in FIG. 5) perpendicular to the main scanning direction. The insulating layer 174 has opening portions 175 at four positions on each pixel electrode 166, and is formed on the transparent substrate 152 so as to cover the pixel electrodes 166 except for the opening portions 175.

The four opening portions 175 are provided in an almost rectangular (almost square) area S on the pixel electrode 166 at the middles of the respective sides of the almost square area S, respectively. These opening portions are equally spaced from each other. Each side of the almost square area S extends along either the main scanning direction or the sub-scanning direction. The organic EL layer 176 extends in the sub-scanning direction so as to cover the almost square area S. For this reason, the organic EL layer 176 is buried in the opening portions 175 and is deposited on the pixel electrode 166. The counter electrode 178 is formed on the organic EL layer 176 and the insulating layer 174. The four opening portions 175 define the micro-light-emitting portions 164 in each of which the organic EL layer 176 emits light in accordance with a current flowing between the pixel electrode 166 and the counter electrode 178. Of the four micro-light-emitting portions 164, two micro-light-emitting portions 164a are nearest to the organic EL elements 162 adjacent in the main scanning direction, and two micro-light-emitting portions 164b are located farther from the organic EL elements 162 adjacent in the main scanning direction than the micro-light-emitting portions 164a. The pixel electrode 166 is made of, for example, ITO. The insulating layer 174 is made of, for example, SiN. The counter electrode 178 is made of, for example, Al. The organic EL layer 176 includes, for example, a hole transport layer (HTL), an emitting layer (EML), and an electron transport layer (ETL).

One area where one pixel electrode 166 faces one counter electrode 178 corresponds to one pixel. One pixel has the four micro-light-emitting portions 164a and 164b. One micro-light-emitting portion 164, i.e., 164a or 164b, corresponds to one sub-pixel. The four micro-light-emitting portions 164 emit light with the same luminance to form one light emission point. For this reason, they are preferably not to be spaced apart from each other too much. The direction of the perpendicular bisector of the straight line joining the centers of each adjacent pair of the micro-light-emitting portions 164 is off the adjacent organic EL element 162. That is, the perpendicular bisector does not extend toward the adjacent organic EL element 162.

In the organic EL element 162, the organic EL layer 176, which emits light upon recombination of holes and electrons, mainly generates heat. Owing to the heat generated by the organic EL layer 176, the temperature difference is relatively small and the temperature is high on the straight line joining the centers of the two adjacent micro-light-emitting portions 164 (one micro-light-emitting portion 164a and one micro-light-emitting portion 164b) in one organic EL element 162. If this almost linear high temperature region is set along the adjacent organic EL element 162, i.e., the distance between the region and the adjacent organic EL element 162 is uniformly short, the generated heat transfers to the adjacent organic EL element 162 and may promote its heat deterioration. However, since the almost linear high temperature region is inclined with respect to the adjacent organic EL element 162, the generated heat does not easily transfer to the adjacent organic EL element 162. That is, as shown in FIG. 5, in the almost linear high temperature region, one micro-light-emitting portion 164a is near the adjacent organic EL element 162, but one micro-light-emitting portion 164b is relatively far from the adjacent organic EL element 162. Therefore, this region does not exert thermal influence on the adjacent organic EL element 162 or does not easily receive thermal influence from the adjacent organic EL element 162. As described above, in this embodiment, each organic EL element 162 having the micro-light-emitting portions 164 is nearest to only one micro-light-emitting portions 164, i.e., the micro-light-emitting portions 164a of the adjacent organic EL element 162. In other words, each organic EL element 162 has the micro-light-emitting portion 164b located relatively far from one adjacent organic EL element 162, the thermal influence between the adjacent organic EL elements 162 is small, and heat is properly dissipated. This improves the service life of each organic EL element 162.

FIG. 7 shows a cross-section of another organic EL element which can replace the bottom emission type organic EL element shown in FIG. 6. The same reference numerals as in FIG. 6 denote the same parts in FIG. 7, and a detailed description will be omitted. The organic EL element shown in FIG. 7 differs from that shown in FIG. 6 in that a heat dissipation portion 184 made of a metal with a high heat transfer coefficient (e.g., copper) is provided on the light exit side. That is, the heat dissipation portion 184 is provided between the transparent substrate 152 and the pixel electrode 166. This structure causes the Joule heat generated by the micro-light-emitting portions 164 to be quickly transferred to the transparent substrate 152 via the heat dissipation portion 184, thus further improving the heat dissipation efficiency. The heat dissipation portion 184 is not located in the propagating direction of light emitted from the micro-light-emitting portion 164, and hence need not be light transmissive. In addition, in order to prevent signal delay due to resistance, the heat dissipation portion 184 is preferably a conductive member having a lower resistivity than the pixel electrode 166.

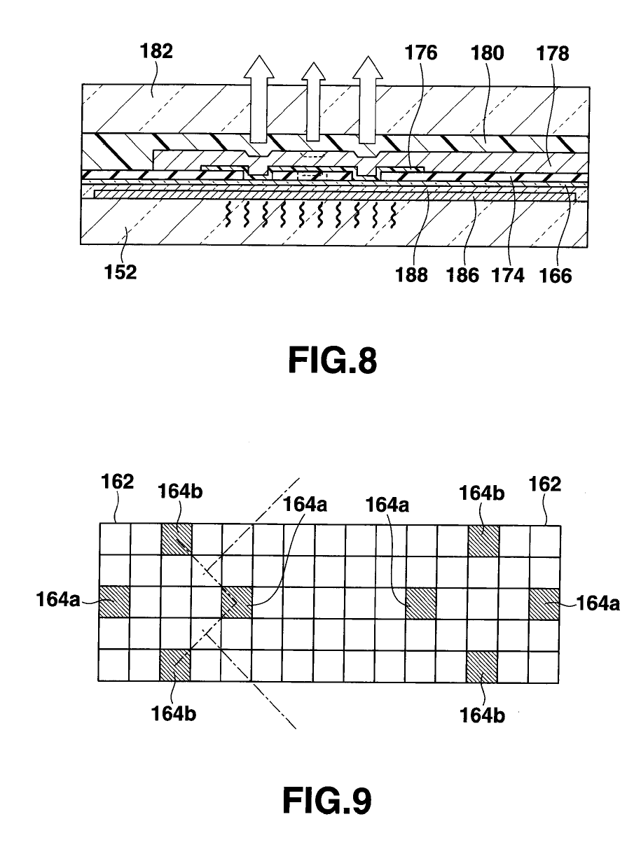

FIG. 8 shows a cross-section of a top emission type organic EL element which can replace the bottom emission type organic EL element shown in FIG. 6. The same reference numerals as in FIG. 6 denote the same parts in FIG. 8, and a detailed description will be omitted. In the organic EL element shown in FIG. 8, a heat dissipation portion 186 made of a heat transfer member similar to the heat dissipation portion 184 and an insulating layer 188 are provided on the transparent substrate 152. The pixel electrodes 166, the insulating layer 174, the organic EL layer 176, the counter electrode 178, the sealing layer 180, and the sealing substrate 182 are provided on the insulating layer 188. The heat dissipation portion 186 two-dimensionally overlays the entire region of the organic EL element 162 including the micro-light-emitting portions 164, and hence a higher heat dissipation effect can be obtained. The counter electrode 178 is made of, for example, ITO which is optically transparent. The insulating layer 188, the counter electrode 178, and the sealing layer 180 are made of optically transparent materials. The pixel electrodes 166 is preferably light reflective. Other details of the insulating layer 174, organic EL layer 176, and counter electrode 178 are the same as those described above.

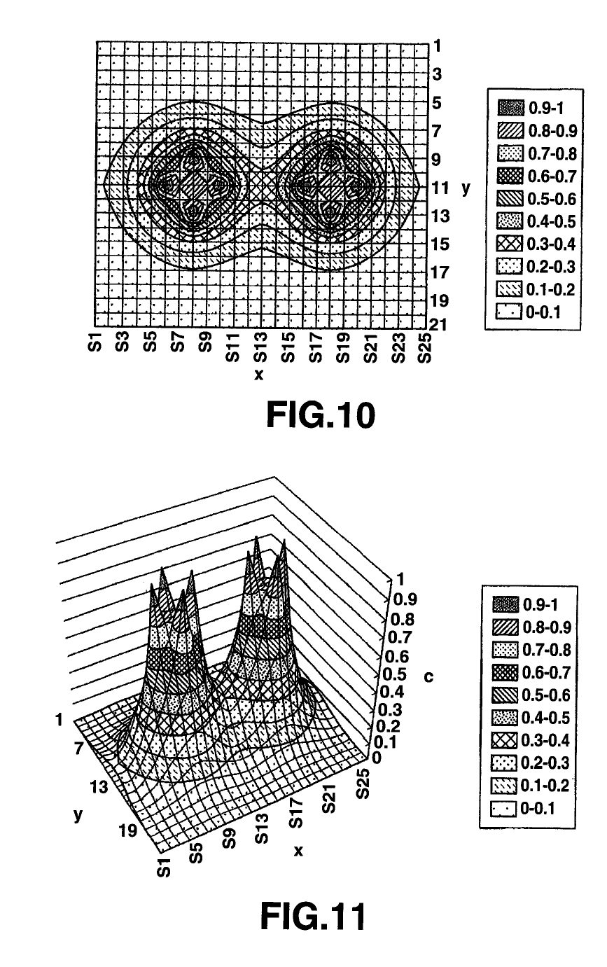

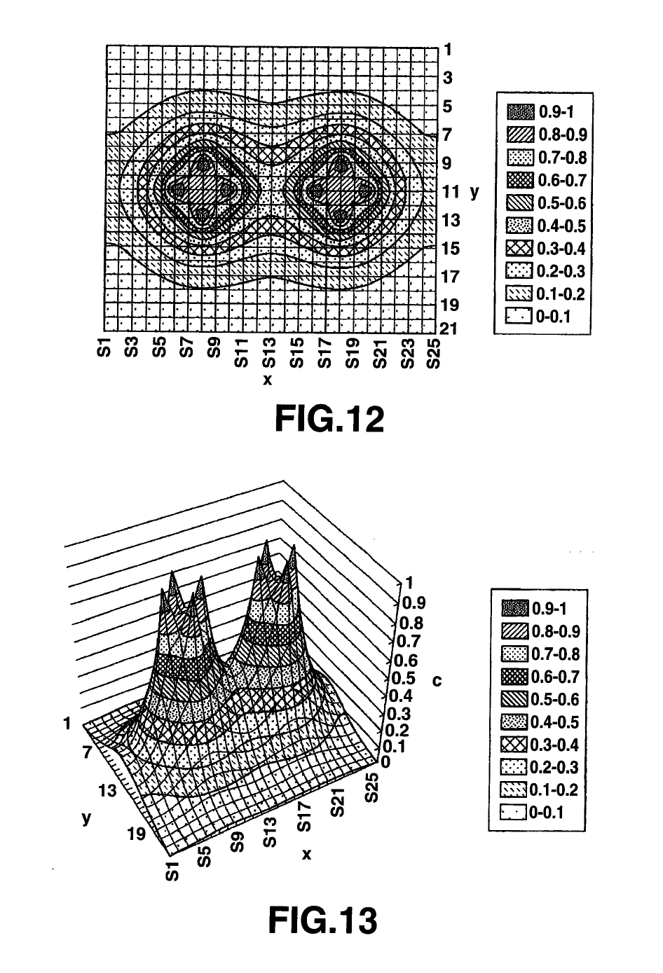

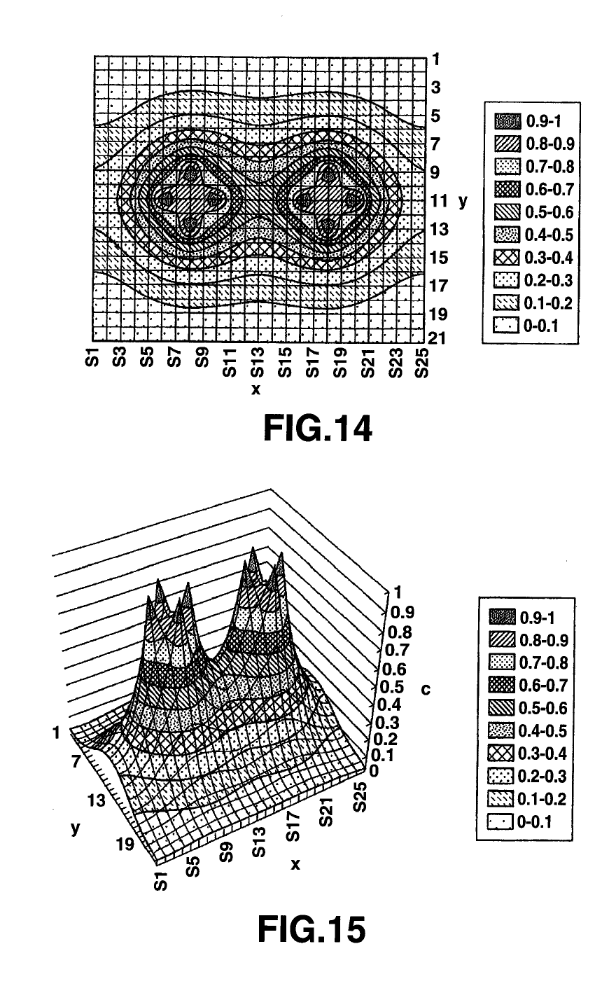

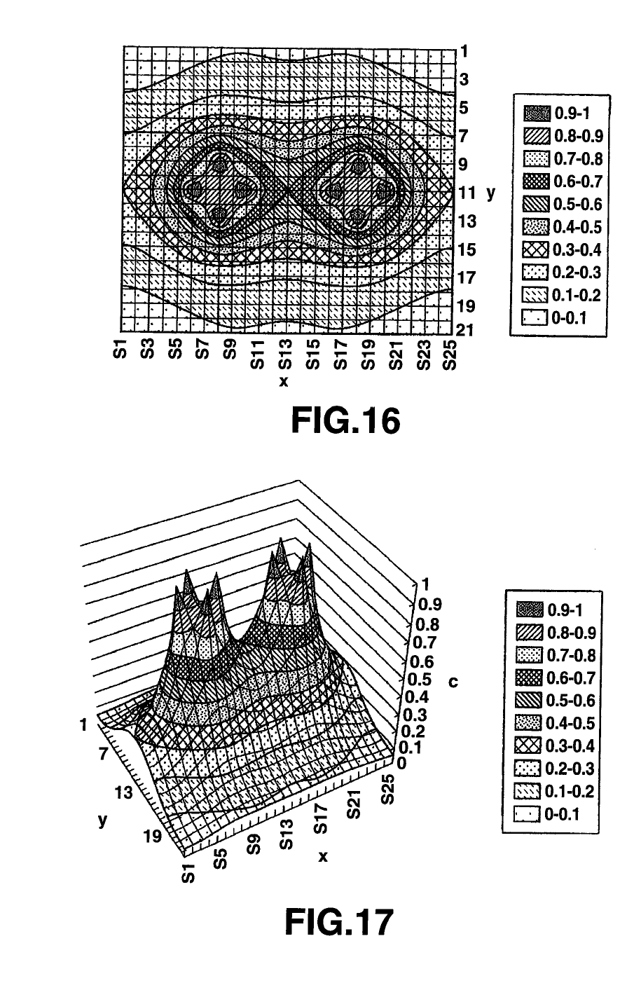

FIG. 9 shows the layout of the micro-light-emitting portions of the organic EL element shown in FIGS. 4 to 8. That is, in this layout, the direction of the perpendicular bisector of the straight line joining the centers of the adjacent two micro-light-emitting portions 164 deviates from the adjacent organic EL element 162. FIGS. 10 to 17 each show the heating pattern of the organic EL element having the micro-light-emitting portions arranged in the layout shown in FIG. 9, and each are a temperature distribution with the highest temperature being normalized to 1.0. FIGS. 10 and 11 show heating patterns obtained 50 ms after heat generation. FIGS. 12 and 13 show heating patterns obtained 80 ms after heat generation. FIGS. 14 and 15 show heating patterns obtained 100 ms after heat generation. FIGS. 16 and 17 show heating patterns obtained 130 ms after heat generation. In this case, a column s13 on the x-axis is located between the adjacent organic EL elements 162.

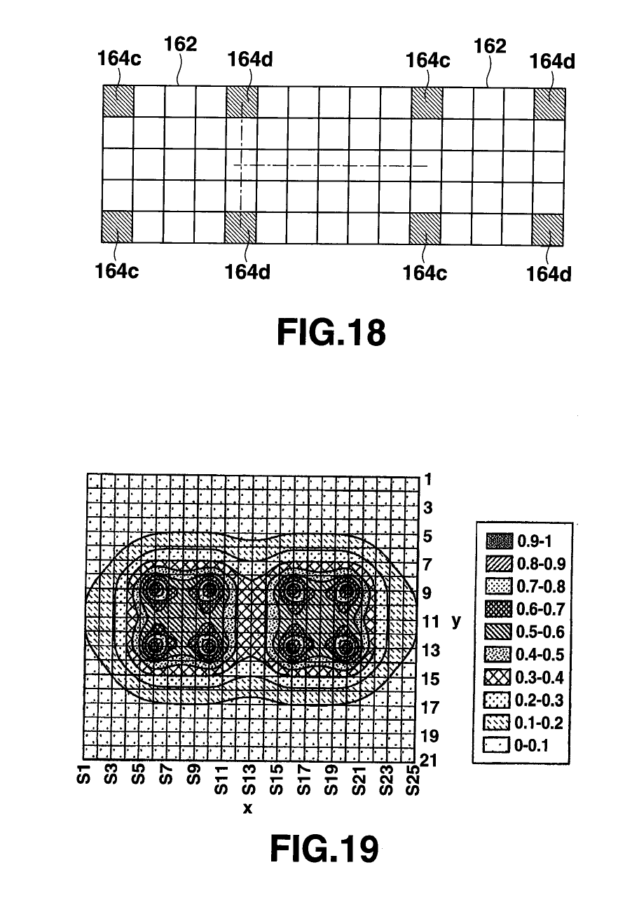

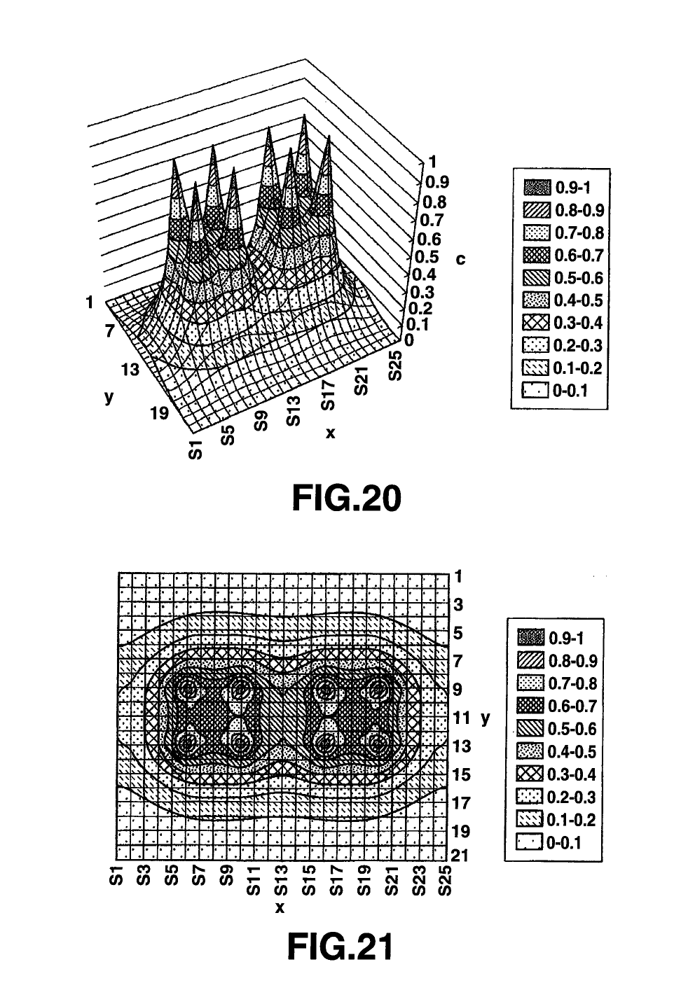

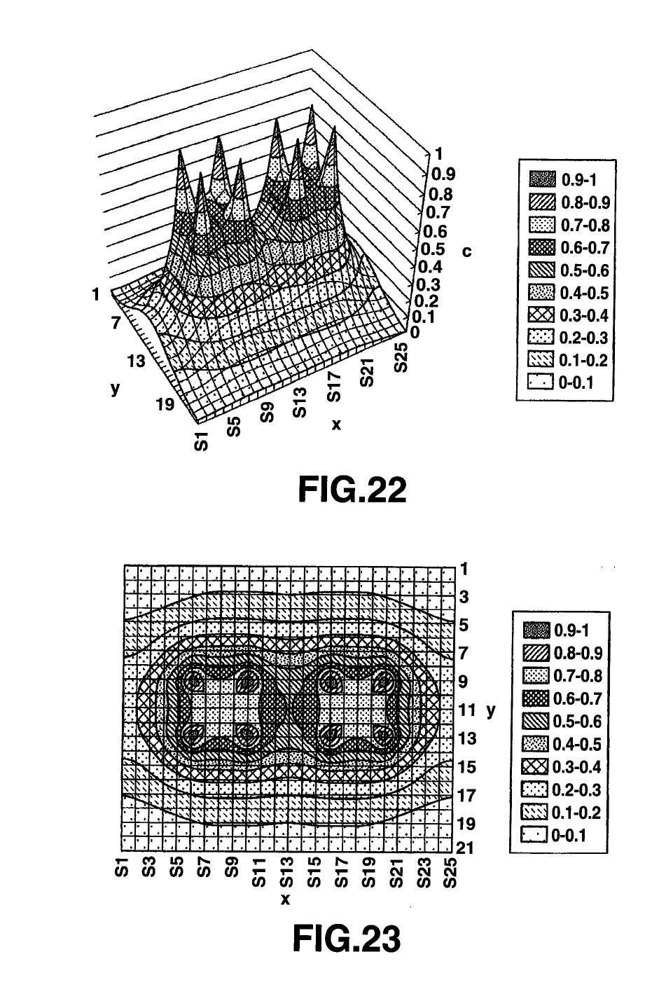

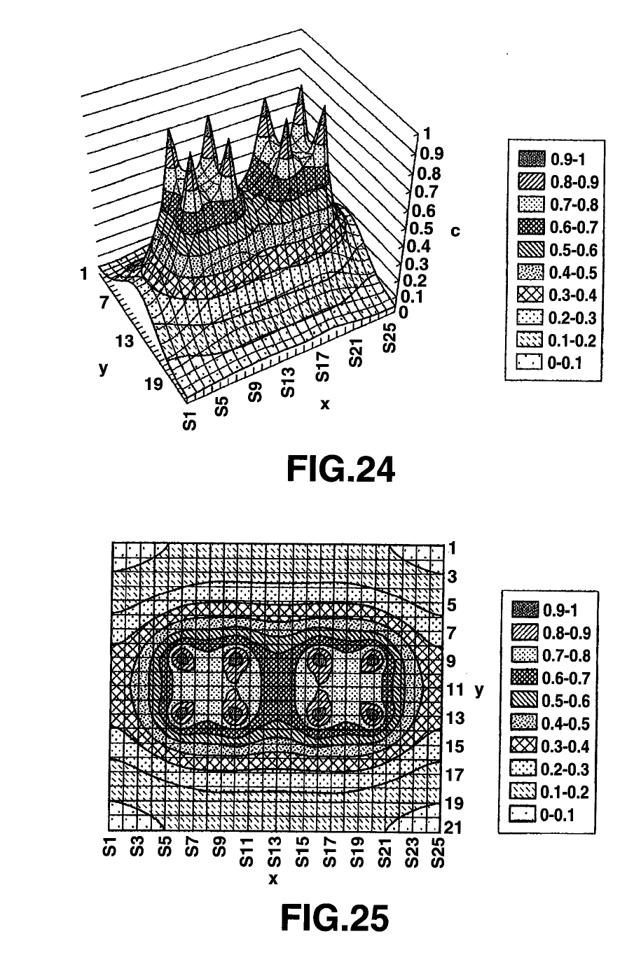

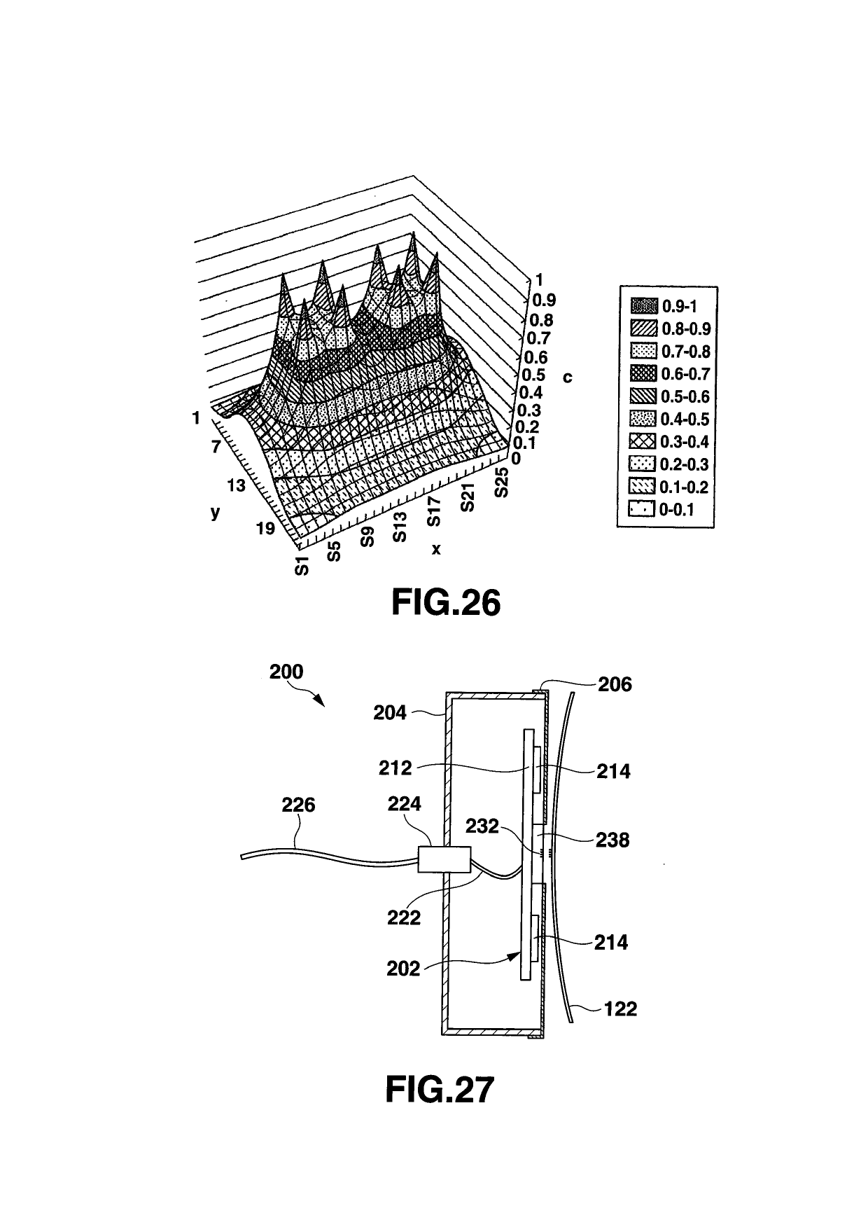

FIG. 18 shows another layout of micro-light-emitting portions in an organic EL element as a comparative example. In this layout, the perpendicular bisector of the straight line joining the centers of the two adjacent micro-light-emitting portions 164 extends to the adjacent organic EL element 162. FIGS. 19 to 26 each show the heating pattern of the organic EL element having the micro-light-emitting portions arranged in the layout shown in FIG. 18. FIGS. 19 and 20 show heating patterns obtained 50 ms after heat generation. FIGS. 21 and 22 show heating patterns obtained 80 ms after heat generation. FIGS. 23 and 24 show heating patterns obtained 100 ms after heat generation. FIGS. 25 and 26 show heating patterns obtained 130 ms after heat generation.

As is apparent from the comparison between the heating patterns shown in FIGS. 10 to 17 and those shown in FIGS. 19 to 26, the temperature distributions at the columns s13 reveal that the layout in FIG. 9 is smaller in thermal influence on adjacent pixels than the layout in FIG. 18, and the layout in FIG. 18 tends to make it more easy to accumulate heat between adjacent pixels and make it more difficult to dissipate heat. Referring to FIG. 18, of the four micro-light-emitting portions 164 of the organic EL element 162, two micro-light-emitting portions 164c or 164d which are adjacent on one side and located on the organic EL element 162 side are equidistant from the adjacent organic EL element 162 (the two micro-light-emitting portions 164d or 164c). For this reason, the almost linear high temperature region joining the two micro-light-emitting portions 164c or 164d faces the organic EL element 162. This makes it easy to accumulate heat and difficult to dissipate heat at the column s13, as shown in FIGS. 19 to 26.

In an electrophotographic printing apparatus, an exposure device optically writes on a photosensitive drum in accordance with print information. In this case, the greatest challenge is to form a light beam to resolve each dot by forming a light spot with a small diameter on the photosensitive drum from which the exposure device is spaced apart by a distance on the millimeter order. As is known, an array type print head having LEDs or organic EL elements as light-emitting sources, a rod lens array is generally used, which is an array of erecting one-to-one imaging lenses as imaging lenses. The optical path length (the gap between the lens and the photosensitive member) is several mm. In this case, the image formed by the rod lens array is obtained by superimposing the images formed by the lenses. Therefore, the positional relationship between the lenses and the respective luminescent elements is not uniform, and exhibits periodic imaging irregularity, resulting in print density irregularity.

In order to use a perfect diffusion organic EL light source as the exposure device of a printing apparatus, it is necessary to form a light beam and resolve each dot. In the case of a resolution of 1,200 dpi, the pitch is approximately 21 μm, and the spot diameter is approximately 30 μm. The focal length is determined by the curvature radius and refractive index of the lens. Assume that the optical path length is 1 mm. This optical path length is set in consideration of the flatness of the photosensitive drum. In addition, if the optical path length is less than 1 mm, an image formation failure is expected to occur due to leakage between the heads or the adhesion of residual toner after transfer onto the head unit. In order to set the optical path length to 1 mm, a curvature radius of approximately 150 μm is required if the refractive index of the lens is 1.5, which is the same as that of an optical glass. It is however difficult from the viewpoint of the manufacture to arrange spherical lenses, each having a radius of 150 μm, in an array at a pitch of 21 μm.

FIG. 27 shows an organic EL head 200 which resolves each dot. The organic EL head 200 includes a luminescent element substrate 202, a back case 204, and a front case 206. The luminescent element substrate 202 includes a transparent substrate 212 made of a glass material or the like, drivers 214, an organic EL element array 232, and a microlens array 238. The luminescent element substrate 202 is electrically connected to a relay connector 224 via a relay interconnection 222, and is electrically connected to an external device via an interconnection 226 connected to the relay connector 224.

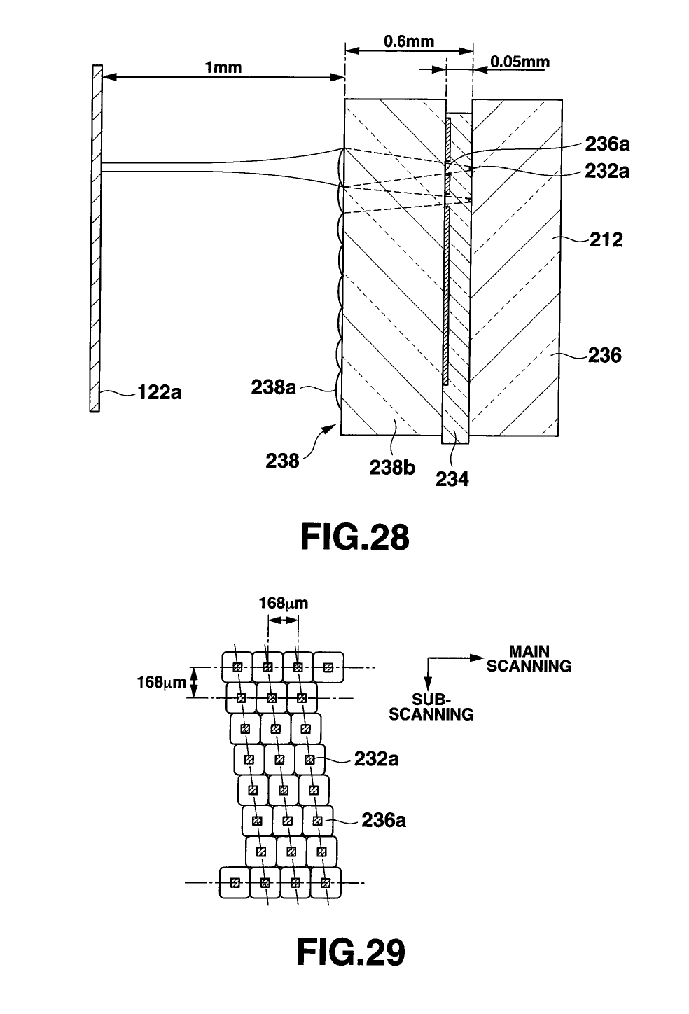

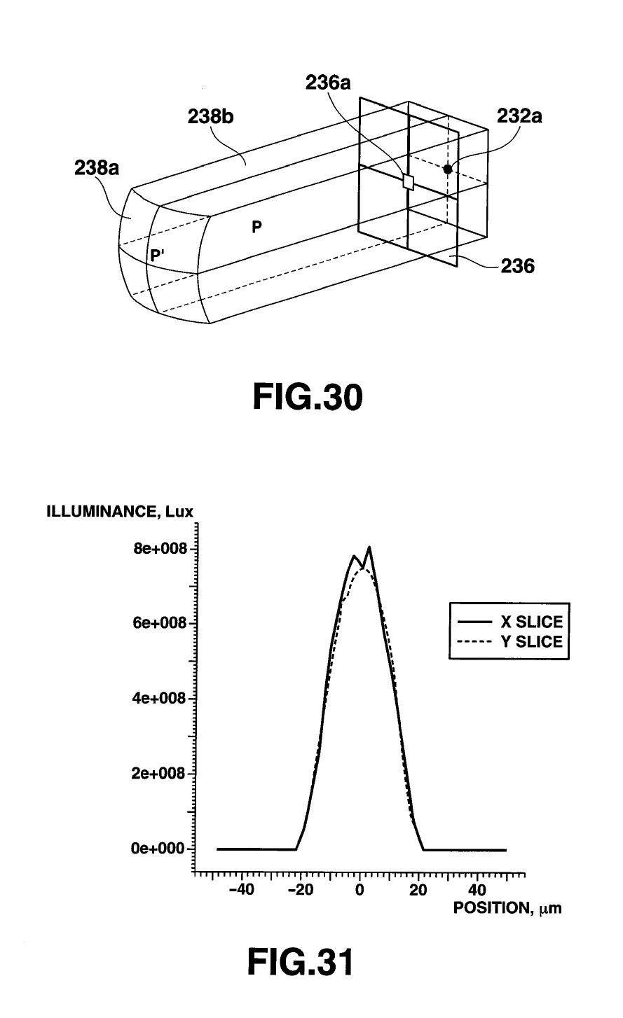

FIG. 28 is an enlarged view of the organic EL element array 232 and microlens array 238. FIG. 29 shows the layout of the arrays of organic EL elements 232a and microlenses 238a. FIG. 30 shows one combination of the organic EL element 232a and the microlens 238a.

As shown in FIG. 28, the transparent substrate 212 on which the organic EL element array 232 is formed is joined to the microlens array 238 via a sealing layer 234. The microlens array 238 includes a transparent substrate 238b of a glass material or the like and the microlenses 238a formed on one surface of the transparent substrate 238b. The microlens array 238 is provided with a light-shielding plate 236 on the surface of the transparent substrate 238b on the opposite side to the surface on which the microlenses 238a are formed. The light-shielding plate 236 has optical openings 236a respectively corresponding to the organic EL elements 232a constituting the organic EL element array 232. When the optical path length is 1 mm, the distance from the organic EL element 232a to the optical opening 236a of the light-shielding plate 236 is, for example, 0.05 mm, and the distance from the organic EL element 232a to the microlens 238a is, for example, 0.6 mm.

Referring to FIG. 28, light emitted from each organic EL element 232a passes through the optical opening 236a of the light-shielding plate 236 which corresponds to the organic EL element 232a, is converted into convergent light by the microlens 238a corresponding to each organic EL element 232a, and is formed into an image on the surface of the photosensitive drum 122. Light emitted from each organic EL element 232a and propagating to another microlens 238a different from the microlens 238a corresponding to the organic EL element 232a is blocked by the light-shielding plate 236. As a result, almost only the light emitted from the organic EL element 232a corresponding to each microlens 238a strikes the microlens 238a.

As shown in FIGS. 29 and 30, each microlens 238a has an optical surface formed by part of a spherical surface having an almost square contour. The organic EL elements 232a and the microlenses 238a are aligned in columns arranged side by side in the sub-scanning direction. Each column linearly extends in the main scanning direction. The organic EL elements 232a and microlenses 238a of each column are shifted from those of the other two columns by a predetermined distance in the main scanning direction.

The pitch of the organic EL elements 232a and microlenses 238a in the main scanning direction is determined by a print resolution. If the resolution is 1,200 dpi, the pitch is 25.6 mm÷1200≈21 μm. For this reason, as shown in FIG. 29, the organic EL elements 232a and the microlenses 238a are arrayed in eight rows in the sub-scanning direction. The organic EL elements 232a and microlenses 238a of the same row are arranged at a pitch of 168 μm in the main scanning direction. As a consequence, the array pitch of the organic EL elements 232a and microlenses 238a of all the eight rows is 21 μm in the main scanning direction. In addition, the organic EL elements 232a and microlenses 238a of the eight rows are arranged at a pitch of 168 μm in the sub-scanning direction.

The organic EL elements 232a of the same row are located at the same position in the sub-scanning direction, and hence are made to simultaneously emit light. The organic EL elements 232a of each row differ in position in the sub-scanning direction from those of the remaining rows, and are made to emit light in synchronism with a printing speed.

Referring to FIG. 29, the rows of the elements (the organic EL elements 232a and the microlenses 238a) are arranged so as to be gradually shifted from each other at a predetermined rate in the main scanning direction as they are shifted in the sub-scanning direction. In other words, the rows of the elements are arranged such that the elements whose positions in the main scanning direction correspond to each other are located on straight lines oblique to the sub-scanning direction. However, the manner of arranging the rows of the elements is not limited to this. As described above, it suffices if only the elements of each row are shifted from those of the other two rows in the main scanning direction by a predetermined distance. In other words, it suffices if only the elements whose positions in the main scanning direction correspond to each other in all the rows are arranged at a pitch of a predetermined distance in the main scanning direction. For example, the rows of the elements may be arranged such that the elements whose positions in the main scanning direction correspond to each other are arranged in a zigzag pattern, i.e., a staggered pattern. This arrangement allows the pitch of the organic EL elements 232a in the main scanning direction to be set to 21 μm. Even if the curvature radius of each microlens 238a is set to 150 μm or more, which is longer than 21 μ, the microlenses 238a can be arranged in correspondence with the organic EL elements 232a.

One side of an organic EL element was set to 10 μm which corresponds to a half pitch of 1,200 dpi, and a light beam tracking simulation of a light spot via a microlens was performed. FIG. 31 shows the light-receiving profile of light emitted from the organic EL element which is applied, via the microlens, to a light-receiving surface spaced apart from the distal end of the microlens by 1 mm. In this case, it is obvious from the values obtained from this graph that the spot diameter (1/e²) on the light-receiving surface is approximately 30 μm, and a good light beam is obtained.

A method of manufacturing the microlens array 238 will be briefly described next. This manufacturing method uses a thermal or optical nanoimprint process. In this case, the optical nanoimprint process is exemplified. First of all, a photo-setting resin (PAK-01: refractive index n≈1.5/TOYO GOSEI K.K.) is stacked on a transparent substrate to a thickness of approximately 100 μm. A mold formed into a concavoconvex shape inverse to the microlens array shown in FIG. 29 is pressed against the resin, and UV light is applied to the resin. This process forms a microlens array having the optical glass integrated with the photo-setting resin. At the same time, the surface opposite to the surface of the transparent substrate on which the microlenses are formed is coated with a material obtained by mixing a photo-setting resin (PAK-01) with a coloring material. A mold having a shape having 20-μm square windows each located on the optical axis of each microlens is pressed again the resin to imprint it. With this process, microlenses aligned in eight rows are molded on one surface of the optical glass, and rectangular light-shielding plate windows are formed on the optical axes of the lenses on the opposite surface. Finally, the microlenses are bonded to the sealed organic EL elements so as to be aligned with them.

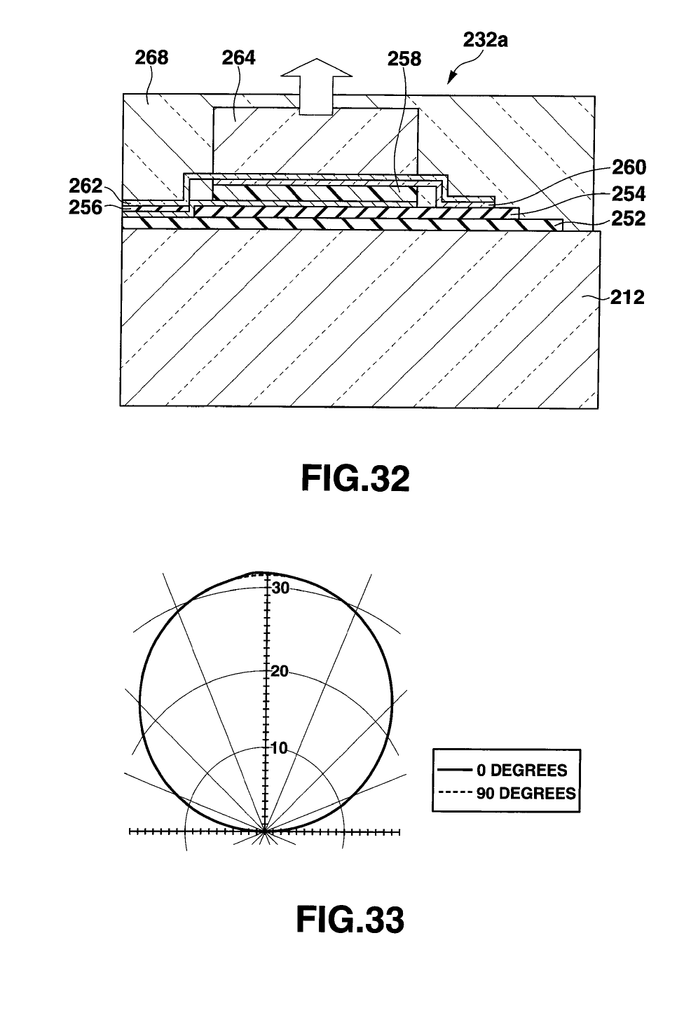

FIG. 32 shows the organic EL element 232a shown in FIGS. 28 to 30. As shown in FIG. 32, the organic EL element 232a is of the top emission type. An anode 256, an organic EL layer 258, a cathode 260, and a sealing film 262 are stacked on insulating layers 252 and 254 on the transparent substrate 212. A core 264 is provided on the sealing film 262, and the entire structure is covered by a sealing layer 266. The core 264 comprises a transparent material having a high refractive index. The sealing layer 266 comprises a transparent material having a lower refractive index than the core 264, and functions as a clad for the core 264. The core 264 and the sealing layer 266 constitute a refractive index difference waveguide.

The organic EL layer 258 generates perfect diffused light in accordance with the voltage applied between the anode 256 and the cathode 260. Light generated by the organic EL layer 258 enters the core 264 via the lower surface of the core 264. Of the light propagating through the core 264, light propagating toward the upper surface of the core 264 directly exits through the upper surface of the core 264. In contrast, light propagating to a side surface of the core 264 at a relatively large incident angle is totally reflected by the interface between the core 264 and the sealing layer 266 due to the refractive index difference between the core 264 and the sealing layer 266, and propagates to the upper surface of the core 264. For this reason, the organic EL element 232a having the core 264 has high light directivity as compared with a general organic EL element without the core 264. As a consequence, the light emitted from the organic EL element 232a efficiently strikes the microlens 238a.

On the other hand, a general organic EL element having a structure obtained by omitting the core 264 from the organic EL element 232a shown in FIG. 32. In such a general organic EL element, it is difficult to cause light to efficiently strike the microlens 238a.

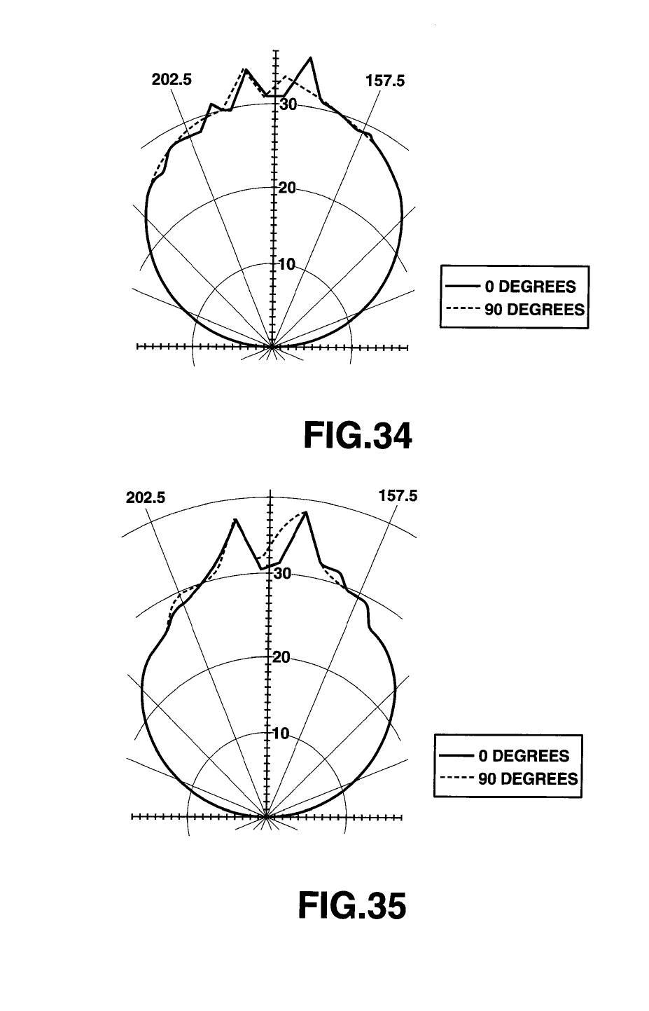

FIG. 33 shows a directivity simulation result on a general organic EL element which emits perfect diffused light. FIG. 34 shows a directivity simulation result on an organic EL element having a refractive index difference waveguide having a length of 10 μm. FIG. 35 shows a directivity simulation result on an organic EL element having a refractive index difference waveguide having a length of 20 μm. It is obvious from these directivity simulation results that providing a refractive index difference waveguide can improve the efficiency at the end face output. The extraction efficiency of light to the outside can be controlled by adjusting the length of the waveguide.

In addition, directivity can be controlled by adjusting the refractive index difference between the core and the clad.

In general, the refractive index difference between the core and the clad of a single-mode optical fiber is as very small as approximately 0.3%. This is because, since light emitted from a light source for an optical fiber has narrow directivity like laser light, if the incident angle of light passing through a portion with a high refractive index is set to be larger than the total reflection angle, the light is totally reflected to pass through only the central portion without leaking to the outside. The reflective index difference between the central portion and the peripheral portion of an optical fiber is decreased to increase the total reflection angle, so that light propagates almost straight in the optical fiber.

In contrast to this, in an organic EL element, since light exiting from an organic EL layer is diffused light, although the rectilinearity of light improves with the relative refractive index difference in an optical fiber, the light leakage increases. For this reason, the refractive index difference between the core and the clad is preferably set to approximately 1 to 2%. This properly decreases the leakage of diffused light and improves the irradiation directivity. As a consequence, the amount of light striking each microlens in FIG. 34 increases by 15% relative to FIG. 33, and that in FIG. 35 increases by 30% relative to FIG. 33.

Although the embodiments of the present invention have been described with reference to the views of the accompanying drawing, the present invention is not limited to these embodiments. The embodiments can be variously modified and changed within the spirit and scope of the invention.

For example, the organic EL element 232a shown in FIG. 29 may have micro-light-emitting portions 164 like the organic EL element 162 shown in FIG. 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light-emitting head of a printing apparatus, the light-emitting head comprising luminescent elements on a substrate, each of the luminescent elements including micro-light-emitting portions,
wherein a direction of a perpendicular bisector of a straight line joining centers of each micro-light-emitting portion of each luminescent element and another micro-light-emitting portion of the same luminescent element which is nearest to the each micro-light-emitting portion is off a luminescent element adjacent to the luminescent element.

2. The light-emitting head according to claim 1, wherein the micro-light-emitting portions of each of the luminescent elements includes a first micro-light-emitting portion nearest to an adjacent luminescent element, and a second micro-light-emitting portion which is nearest to the first micro-light-emitting portion, with a distance to the adjacent luminescent element being longer than a distance between the first micro-light-emitting portion and the adjacent luminescent element,
wherein a direction of a perpendicular bisector of a straight line joining centers of the first micro-light-emitting portion and the second micro-light-emitting portion is off a luminescent element adjacent to the luminescent element.

3. The light-emitting head according to claim 1, further comprising first electrodes, at least one second electrode facing the first electrodes, and an emitting layer and an insulating layer which are located between the first electrodes and the second electrode, and the insulating layer including opening portions in each of areas where each of the first electrodes faces the second electrode,
wherein each of the opening portions defines one of the micro-light-emitting portions.

4. The light-emitting head according to claim 1, in which the luminescent elements are staggered arranged at a predetermined pitch in a main scanning direction, and which further comprises microlenses which respectively correspond to the luminescent elements and each have a curvature radius larger than the predetermined pitch.

5. The light-emitting head according to claim 1, wherein the luminescent element includes the four micro-light-emitting portions.

6. The light-emitting head according to claim 5, which further comprises first electrodes, at least one second electrode facing the first electrodes, and an emitting layer located between the first electrodes and the second electrode,
wherein the micro-light-emitting portions are provided in a substantially rectangular area on the first electrode and the micro-light-emitting portions are provided at middles of sides of the substantially rectangular area.

7. The light-emitting head according to claim 6, wherein each side of the substantially rectangular area extends along one of a main scanning direction and a sub-scanning direction.

8. The light-emitting head according to claim 1, which further comprises first electrodes, at least one second electrode facing the first electrodes, and an emitting layer and a heat dissipation portion which are located between the first electrodes and the second electrode,
wherein the heat dissipation portion is located between the substrate and one of the first electrodes.

9. The light-emitting head according to claim 1, wherein the light-emitting head comprises an organic EL head.

10. A light-emitting head of a printing apparatus, the light-emitting head comprising:
luminescent elements staggered arranged at a predetermined pitch in a main scanning direction; and
microlenses which respectively correspond to the luminescent elements and each have a curvature radius larger than the predetermined pitch.

11. The light-emitting head according to claim 10, wherein a microlens array on which the microlenses are formed includes a light-shielding plate on a side opposite to a surface on which the microlenses are formed.

12. The light-emitting head according to claim 10, wherein the light-shielding plate includes optical openings respectively corresponding to the luminescent elements.

13. The light-emitting head according to claim 10, further comprising
first electrodes,
at least one second electrode facing the first electrodes,
an emitting layer located between the first electrodes and the second electrode,
a sealing film on a multilayer structure of the first electrodes, the emitting layer, and the second electrode, and
a core on the sealing film.

14. The light-emitting head according to claim 13, wherein the sealing layer comprises a material having a lower refractive index than the core.

15. A printing apparatus including a printing unit which prints a toner image on a printing medium,
the printing unit comprising a photosensitive drum, a charging roller which uniformly charges a surface of the photosensitive drum, a light-emitting head which forms an electrostatic latent image on the photosensitive drum, a developing device which develops the electrostatic latent image by attracting toner to the electrostatic latent image, and a transfer roller which transfers the toner attracted to the electrostatic latent image onto a sheet,
the light-emitting head includes luminescent elements on a substrate,
each of the luminescent elements including micro-light-emitting portions,
wherein a direction of a perpendicular bisector of a straight line joining centers of each micro-light-emitting portion of each luminescent element and another micro-light-emitting portion of the same luminescent element which is nearest to the each micro-light-emitting portion is off a luminescent element adjacent to the luminescent element.

16. The printing apparatus according to claim 15, wherein the micro-light-emitting portions of each of the luminescent elements includes a first micro-light-emitting portion nearest to an adjacent luminescent element, and a second micro-light-emitting portion which is nearest to the first micro-light-emitting portion, with a distance to the adjacent luminescent element being longer than a distance between the first micro-light-emitting portion and the adjacent luminescent element,
wherein a direction of a perpendicular bisector of a straight line joining centers of the first micro-light-emitting portion and the second micro-light-emitting portion is off a luminescent element adjacent to the luminescent element.

17. The printing apparatus according to claim 15, wherein the light-emitting head includes first electrodes, at least one second electrode facing the first electrodes, and an emitting layer and an insulating layer which are located between the first electrodes and the second electrode,
the insulating layer including opening portions in each of areas where each of the first electrodes faces the second electrode,
wherein each of the opening portions defines one of the micro-light-emitting portions.

18. The printing apparatus according to claim 15, in which the luminescent elements are staggered arranged at a predetermined pitch in a main scanning direction, and which further comprises microlenses which respectively correspond to the luminescent elements and each have a curvature radius larger than the predetermined pitch.

19. The printing apparatus according to claim 15, wherein the light-emitting head includes first electrodes, at least one second electrode facing the first electrodes, and an emitting layer located between the first electrodes and the second electrode,
the luminescent element includes the four micro-light-emitting portions,
wherein the micro-light-emitting portions are provided in a substantially rectangular area on the first electrode and the micro-light-emitting portions are provided at middles of sides of the substantially rectangular area.

20. The printing apparatus according to claim 15, wherein the light-emitting head comprises an organic EL head.
